(19) United States
(12) Patent Application Publication
(10) Pub. No.: US 2009/0073583 A1
(43) Pub. Date: Mar. 19, 2009

(54) LENS WITH PROTRUSIONS

(75) Inventor: JEN-TSORNG CHANG, Tu-Cheng (TW)

Correspondence Address: PCE INDUSTRY, INC.;ATT. CHENG-JU CHIANG, 458 E. LAMBERT ROAD, FULLERTON, CA, 92835, US

(73) Assignee: HON HAI PRECISION INDUSTRY CO., LTD., Tu-Cheng (TW)

(21) Appl. No.: 12/177,382

(22) Filed: Jul. 22, 2008

(30) Foreign Application Priority Data
Sep. 14, 2007 (CN) 200710201713.4

(51) Int. Cl. G02B 7/02

(52) U.S. Cl. 359/819

(57) ABSTRACT

An exemplary lens includes an active part and a nonactive part. The active part is configured for refracting light traveling therethrough. The nonactive part surrounds the active part. The nonactive part has a plurality of protrusions formed on a surface thereof. The protrusions are structured and arranged along an imaginary substantial circle on the nonactive part.

### BACKGROUND

1. Technical Field

The present invention relates to optical imaging devices and, particularly, to a lens with protrusions.

2. Description of Related Art

With the development of optical imaging technology, electronic devices, such as digital cameras and mobile phones are provided with digital camera modules. A high quality lens module is desired to produce high quality images. At the same time, mobile phones and other consumer electronics products are becoming lighter, thinner, shorter and smaller; therefore, digital camera modules inside the mobile phones are becoming smaller and smaller. In the assembly of the optical lens, due to the miniaturization of the lens, the lenses will become increasingly thin.

Typically, ultra-thin plastic lenses have an insufficient structural strength due to the lenses being too thin. The insufficient structural strength will cause extrusion deformation of the lens when assembled into the lens barrel, which will affect the imaging quality of the lens module, or even make the lens module to be inferior.

Therefore, a new lens is desired to overcome the above mentioned problems.

### SUMMARY

An exemplary lens includes an active part and a nonactive part. The active part is configured for refracting light traveling therethrough. The nonactive part surrounds the active part. The nonactive part has a plurality of protrusions formed on a surface thereof. The protrusions are structured and arranged along an imaginary substantial circle on the nonactive part.

### BRIEF DESCRIPTION OF THE DRAWINGS

Many aspects of the embodiments can be better understood with references to the following drawings. The components in the drawings are not necessarily drawn to scale, the emphasis instead being placed upon clearly illustrating the principles of the present embodiments. Moreover, in the drawings, like reference numerals designate corresponding parts throughout the several views.

FIG. 1 is a schematic, perspective view of a lens, according to a first embodiment.

FIG. 2 is a schematic, plan view of the lens of FIG. 1.

FIG. 3 is a schematic, plan view of a lens, according to a second embodiment.

FIG. 4 is a schematic, perspective view of a lens, according to a third embodiment.

FIG. 5 is a schematic, perspective view of a lens, according to a fourth embodiment.

FIG. 6 is a schematic, perspective view of a lens, according to a fifth embodiment.

FIG. 7 is a schematic, plan view of the lens of FIG. 6.

### DETAILED DESCRIPTION OF THE EMBODIMENTS

Embodiments will now be described in detail below with reference to the drawings.

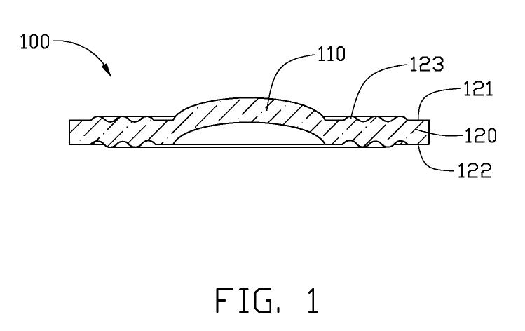

Referring to FIG. 1, a lens 100 of a first embodiment is shown. The lens 100 includes an active part 110, a nonactive part 120 surrounding the active part 110. The active part 110 is configured for refracting light traveling therethrough. The nonactive part 120 is configured for fixing the lens 100 to a lens barrel.

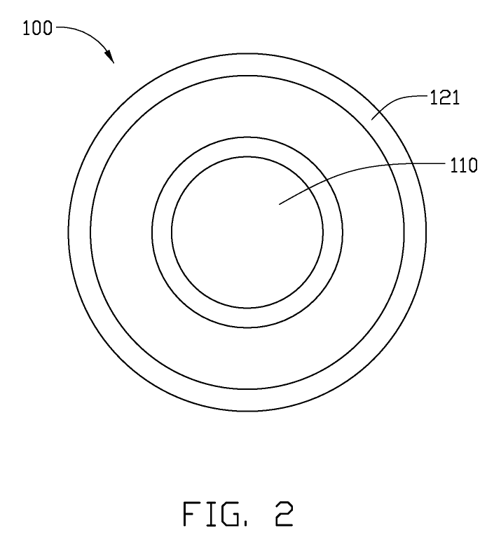

Referring to FIGS. 1-2, the nonactive part 120 has two opposite surfaces 121,122. A plurality of protrusions 123 are formed on the two surfaces 121,122 of the nonactive part 120. The protrusions 123 are structured and arranged along an imaginary substantial circle on the nonactive part 120. In the present embodiment, the protrusions 123 are annular protrusions. It is to be noted that the protrusions 123 can also be set only on the surface 121 or the surface 122 of the nonactive part 120.

The protrusions 123 in cross section along the radial direction of the lens 100 have a sine wave profile or a cosine wave profile. A height of the protrusions 123 relative to the surface 122 is in a range from 10 μm to 100 μm.

The lens 100 is a plastic lens and, particularly, is an ultra-thin plastic lens. In the present embodiment, the thickness of the nonactive part 120 of the lens 100 including the protrusions 123 is less than 0.3 mm.

The protrusions 123 can also have other configurations, such as a rectangular wave or a sawtoothed wave and so on.

The protrusions 123 can be integrally formed with the lens 100.

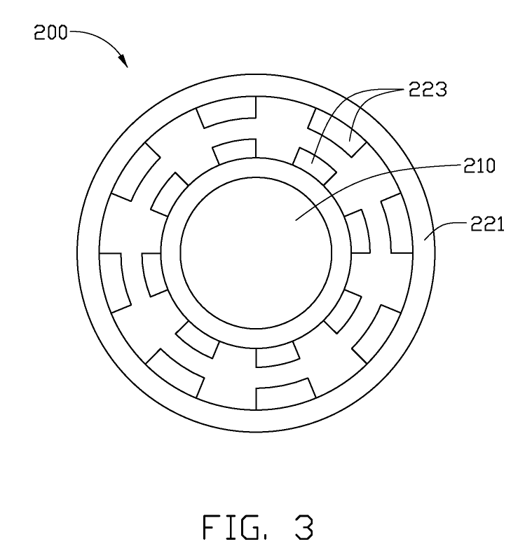

Referring to FIG. 3, a lens 200 of a second embodiment is shown. The lens 200 includes an active part 210, a nonactive part 220 surrounding the active part 210. The active part 210 is configured for refracting light traveling therethrough. A plurality of protrusions 223 are formed on the surface 221 and 222 of the nonactive part 220. The shape of the protrusions 223 is different from that of the protrusions 123 of the first embodiment. In the present embodiment, the protrusions 223 are annular and are alternately structured and arranged along an imaginary circle on the nonactive part 220.

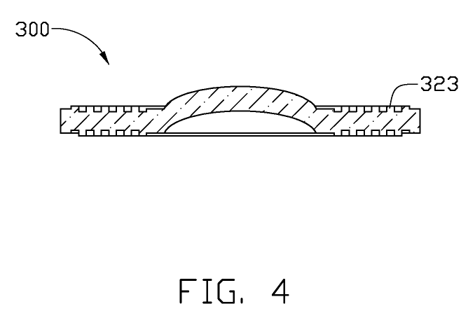

Referring to FIG. 4, a lens 300 of a third embodiment is shown. The lens 300 includes a plurality of protrusions 323. The protrusions 323 in cross section along the radial direction of the lens 300 are different from that of the protrusions 123 of the first embodiment. In the present embodiment, the protrusions 323 in cross section along the radial direction of the lens 300 are a rectangular wave profile.

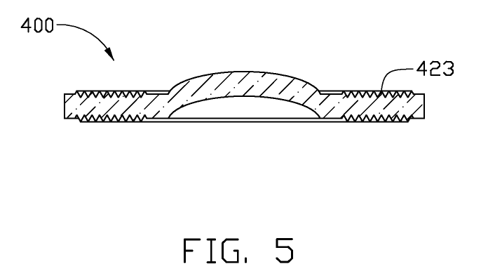

Referring to FIG. 5, a lens 400 of a fourth embodiment is shown. The lens 400 includes a plurality of protrusions 423. The protrusions 423 in cross section along the radial direction of the lens 400 are different from that of the protrusions 123 of the first embodiment. In the present embodiment, the protrusions 423 in cross section along the radial direction of the lens 400 are a sawtoothed wave profile.

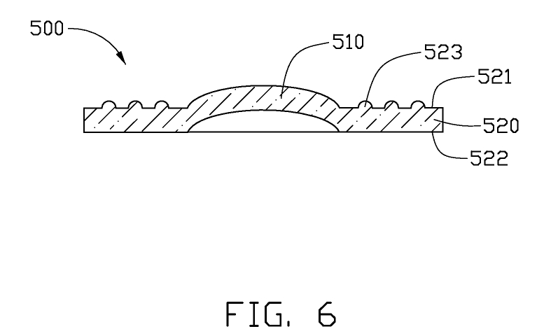

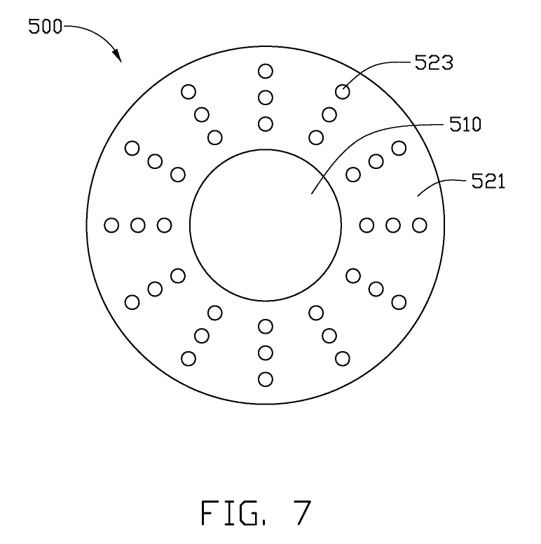

Referring to FIGS. 6-7, a lens 500 of a fifth embodiment is shown. The lens 500 includes an active part 510, a nonactive part 520 surrounding the active part 510. The active part 510 is configured for refracting light traveling therethrough. The nonactive part 520 is configured for fixing the lens 500 to a lens barrel.

The nonactive part 520 has two opposite surfaces 521,522. A plurality of protrusions 523 are formed on the surface 521 of the nonactive part 120. The protrusions 523 are structured and arranged along an imaginary circle on the nonactive part 520. In the present embodiment, the protrusions 523 are dot-shaped. The protrusions 523 can also be arranged on both surfaces 521,522. The protrusions 523 are arranged in a dispersion shape from the active part 510 to the outer of the lens 500 along the surface 521 of the nonactive part 520. In the present embodiment, the protrusions 523 are round dots. It should be noted that the shape of the protrusions 523 can also be rectangular, triangular and polygonal. The protrusions 523 are evenly arranged on the active part.

The at least one surface of the nonactive part of the lens has a plurality of protrusions. This structure can enhance the structural strength of the lens and improve the capability of anti-extrusion and anti-deformation of the lens. Therefore, it can effectively improve the conformity rate of production of lens module and enhance the efficiency of the assembly of lens module.

While certain embodiments have been described and exemplified above, various other embodiments from the foregoing disclosure will be apparent to those skilled in the art. The present invention is not limited to the particular embodiments described and exemplified but is capable of considerable variation and modification without departure from the scope of the appended claims.

What is claimed is:

1. A lens comprising:
an active part configured for refracting light traveling therethrough;
a nonactive part surrounding the active part, the nonactive part having a plurality of protrusions formed on a surface thereof, the protrusions being structured and arranged along an imaginary circle on the nonactive part.

2. The lens as claimed in claim 1, wherein the protrusions are annular protrusions.

3. The lens as claimed in claim 2, wherein the protrusions in cross section along the radial direction of the lens have a sine wave profile, a cosine wave profile, a rectangular wave profile or a sawtoothed wave profile.

4. The lens as claimed in claim 1, wherein the protrusions are dot-shaped.

5. The lens as claimed in claim 4, wherein the protrusions are round, rectangular, triangular or polygonal.

6. The lens as claimed in claim 1, wherein the protrusions are evenly arranged on the nonactive part.

7. The lens as claimed in claim 1, wherein a height of the protrusions relative to the surface is in a range from 10 μm to 100 μm.

8. The lens as claimed in claim 1, wherein a thickness of the nonactive part of the lens is less than 0.3 mm.

9. A lens comprising:
a central optically active part configured for refracting light traveling therethrough;
a peripheral optically nonactive part surrounding the central active part, the peripheral nonactive part having a thickness of less than 0.3 mm, the peripheral nonactive part having a plurality of protrusions structured and arranged along an imaginary substantial circle on a surface thereof.

10. The lens as claimed in claim 9, wherein the protrusions are annular protrusions.

11. The lens as claimed in claim 10, wherein the protrusions in cross section along the radial direction of the lens has a sine wave profile, a cosine wave profile, a rectangular wave profile or a sawtoothed wave profile.

12. The lens as claimed in claim 9, wherein the protrusions are dot-shaped.

13. The lens as claimed in claim 12, wherein the protrusions are round, rectangular, triangular or polygonal.

14. The lens as claimed in claim 9, wherein the protrusions are evenly arranged on the nonactive part.

15. The lens as claimed in claim 9, wherein a height of the protrusions relative to the surface is in a range from 10 μm to 100 μm.
